(19) United States
(12) Patent Application Publication
(10) Pub. No.: US 2023/0415344 A1
(43) Pub. Date: Dec. 28, 2023

(54) ROBOT WATCHDOG

(71) Applicant: THE JOHNS HOPKINS UNIVERSITY, Baltimore, MD (US)

(72) Inventors: Dan Stoianovici, Reisterstown, MD (US); Doru Petrisor, Lutherville, MD (US)

(21) Appl. No.: 18/248,834

(22) PCT Filed: Oct. 12, 2021
(86) PCT No.: PCT/US2021/054586

§ 371 Date: Apr. 12, 2023

Related U.S. Application Data
(60) Provisional application No. 63/090,464, filed on Oct. 12, 2020.

(51) Int. Cl. B25J 9/16; B25J 9/10

(52) U.S. Cl. CPC B25J 9/1674; B25J 9/161; B25J 9/101; B25J 9/1643

(57) ABSTRACT

Robot watchdog software is responsible for monitoring the state of the system and resulting motion and reformulating commands due to task changes and dynamic conditions. However, if the robot watchdog software slows down or stalls, the motion control board remains unsupervised and robotic motion may become hazardous. The addition of a hardware watchdog mitigates the likelihood of this hazard occurring. A hybrid software-hardware robot watchdog is described herein. A fail-safe robotic system is implemented with a two tier software-hardware check system: the software checks the robotic hardware and in turn a hardware watchdog checks the activity of the software.

### CROSS REFERENCE TO RELATED APPLICATIONS

This application claims the benefit of U.S. Provisional Patent Application No. 63/090,464 filed on Oct. 12, 2020, which is incorporated by reference, herein, in its entirety.

### FIELD OF THE INVENTION

The present invention relates generally to robotics. More particularly the present invention relates to a fail-safe robotics system with integrated checks on functionality.

### BACKGROUND OF THE INVENTION

Computer controlled actuated mechanical systems, such as robot manipulators, execute motion under digital commend. If motion control is faulty, the resulting motion does not follow its intended path or target, and there is a risk of being dangerous to humans and materially destructive. Special applications, such as robots for medical application, or advanced weapon systems require special watchdog systems to mitigate this risk as much as possible.

Robot watchdogs are normally implemented in software. These software based robot watchdogs monitor the state of the system and correct faulty conditions and/or interrupt motion. However, software based watchdogs are vulnerable to software errors or crashes, which may not be deterministic.

It would therefore be advantageous to provide a fail-safe robotics system with integrated checks on functionality.

### SUMMARY

According to a first aspect of the present invention a system for providing robotic control includes a hardware watchdog configured to provide control over a robot manipulator. The system also includes a software watchdog configured to run on a processing device and programmed to provide thread-safe architecture over real-time and non-real-time processes of the hardware watchdog and robot manipulator.

In accordance with an aspect of the present invention, the system further includes a system of emergency switches. The system includes momentary single pole switches. The system includes a redundancy system configured to prevent safety failures. The system includes a watchdog circuit with fail-up and fail-down checks. The system includes electronics configured to facilitate a fail-down check, a fail-up check, a fail-down and a fail-up check, latch, relay, and visual status.

In accordance with another aspect of the present invention, a hybrid hardware-software watchdog with thread-safe architecture over real-time and non-real-time processes. The hybrid device further includes a system of emergency switches. The hybrid device includes momentary single pole switches. The hybrid device includes a redundancy system configured to prevent safety failures. The hybrid device includes a watchdog circuit with fail-up and fail-down checks. The hybrid device includes electronics configured to facilitate a fail-down check, a fail-up check, a fail-down and a fail-up check, latch, relay, and visual status.

### BRIEF DESCRIPTION OF THE DRAWINGS

The accompanying drawings provide visual representations which will be used to more fully describe the representative embodiments disclosed herein and can be used by those skilled in the art to better understand them and their inherent advantages. In these drawings, like reference numerals identify corresponding elements and:

FIG. 1 illustrates a flow diagram for a hybrid software-hardware, real-time watchdog architecture.

FIG. 2 illustrates a schematic view of circuit blocks according to an embodiment of the present invention.

FIG. 3 illustrates a schematic view of a hardware watchdog electronic circuit according to an embodiment of the present invention.

### DETAILED DESCRIPTION OF THE PREFERRED EMBODIMENTS

The presently disclosed subject matter now will be described more fully hereinafter with reference to the accompanying Drawings, in which some, but not all embodiments of the inventions are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated Drawings. Therefore, it is to be understood that the presently disclosed subject matter is not to be limited to the specific embodiments disclosed and that modifications and other embodiments are intended to be included within the scope of the appended claims.

Robot manipulators are actuated by motors and monitored by sensors, typically including joint position encoders and limit switches. Motion is commonly controlled by specialized motion control boards (MC) through motor drivers. Because motion is time dependent, it must be controlled in real-time. As such, MCs typically use onboard digital signal processors (DSP) that control the motion at the level of each axis in real-time. This allows the upper levels of the robot software such as the Main command definition and User Interface (UI) to run under a non-real-time operating system (i.e. Microsoft Windows) typically on a PC. Among other application specific tasks, the PC software reads data and passes commands to the MC, which is responsible to execute the commands in real-time in a closed-loop feedback control system. In turn, the software is responsible for monitoring the state of the system and resulting motion (software watchdog), and reformulating commands due to task changes and dynamic conditions. However, if the software slows down or stalls, the MC remains unsupervised and motion may become hazardous. The addition of a hardware watchdog mitigates the likelihood of this hazard occurring. A hybrid software-hardware watchdog is described herein. A fail-safe robotic system is implemented with a two tier software-hardware check system. The software checks the robotic hardware and in turn a hardware watchdog checks the activity of the software.

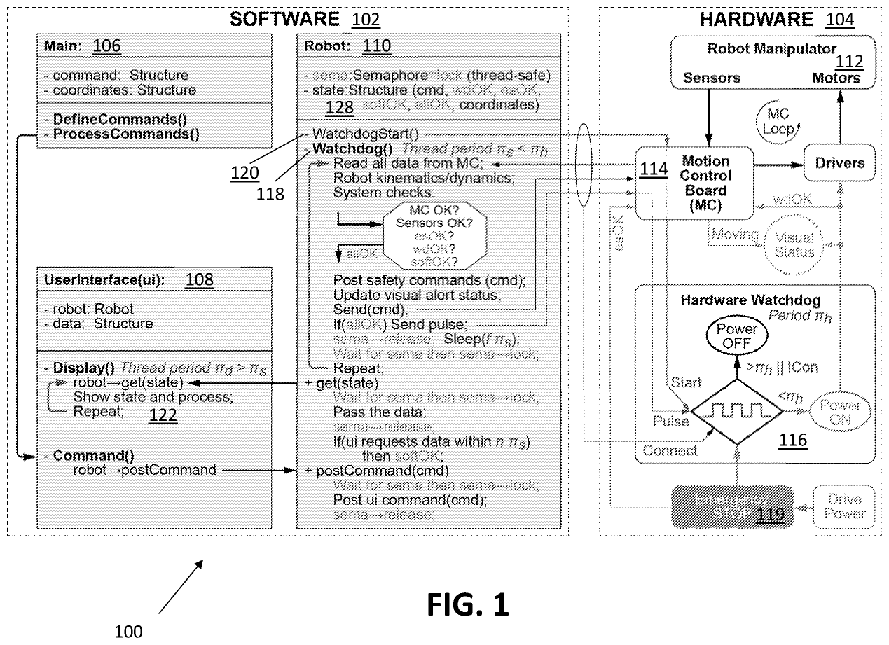

A hybrid hardware and software watchdog, according to the present invention, mitigates intrinsic software errors by integration of the software component with a hardware component. The hybrid software plus hardware structure allows overall human supervision of both the software and robotics components. Robot manipulators are actuated by motors and monitored by sensors, typically including joint position encoders and limit switches. Motion is commonly controlled by specialized motion control boards (MC) through motor drivers, as illustrated in FIG. 1. FIG. 1 illustrates a flow diagram for a hybrid software-hardware, real-time watchdog architecture. Because motion is time dependent, it must be controlled in real-time. As such, MCs typically use onboard digital signal processors (DSPs) that control the motion at the level of each axis in real-time. This allows the upper levels of the robot software such as the Main command definition and User Interface (UI) to run under a non-real-time operating system (i.e. Microsoft Windows) typically on a PC. Among other application specific tasks, the PC software reads data and passes commands to the MC, which is responsible to execute the commands in real-time in a closed-loop feedback control system. In turn, the software is responsible to monitor the state of the system and resulting motion (software watchdog), and reformulate commands due to task changes and dynamic conditions. However, if the software slows down or stalls, the MC remains unsupervised and motion may become hazardous. The addition of a hardware watchdog mitigates the likelihood of this hazard occurring.

More specifically, as illustrated in FIG. 1, a fail-safe robotic system 100 is implemented with a two-tier software-hardware check system: the software watchdog checks the robotic hardware and in turn a hardware watchdog checks the activity of the software. A thread-safe real-time workflow is used to coordinate the checks, command inputs, and motion control. The flowchart that illustrates the architecture and relationship between the components of the robot system, user interface, and watchdog is presented in FIG. 1.

The fail-safe robotic system 100 includes a software component 102 and a hardware component 104. The software component 102 includes a main class 106, a user interface 108, and a robot class 110. The hardware component 104 includes a robotic manipulator 112 or other robotic actuator known to or conceivable to one of skill in the art. The hardware component 104 also includes a motion control board 114, drivers, and a hardware watchdog 116.

The main class 106 implements the specific, application dependent tasks of the robot, as illustrated in FIG. 1. In a generic representation, it defines the tasks and makes them available for processing. Commands are passed along to the user interface 108 that augments human control and maintains the communication with the hardware through the robot class 110.

The primary safety component in the robot class is a thread called Watchdog( ) 118. The hardware component 104 includes the hardware Watchdog 116. The hardware watchdog 116 takes the form of an electronic circuit. The hardware Watchdog 116 is a timer circuit that keeps its relay closed for as long as it is supplied with a train of pulses of period πₕ or faster. The software Watchdog thread 118 is a non-real time thread that runs with a period of approximately πₛ. In an operation that is considered normal, the period of the Watchdog thread 118 does not increase above πₕ. The electronic circuit of the hardware watchdog 116 is serialized in the power supply chain of the motor drivers, together with an Emergency Stop switch 119, so that a failure of the Watchdog thread 118 to provide sufficiently fast pulses would halt the motors by interrupting power. The Watchdog thread 118 sends pulse commands through the MC or another digital interface. Moreover, the hardware watchdog 116 monitors the connection to the software computer (Connect) and drops power should this be disconnected.

The hardware Watchdog 116 should not be started from Watchdog thread 118, so that if pulses lapse momentarily, they cannot be restarted by next loops of the thread. This eliminates potential transient power glitches. As such, an additional signal is required to start the hardware Watchdog 116 and is sent by a WatchdogStart( ) method 120 through the motion control board 114 of the hardware.

Several non-real-time and real-time processes are active concurrently:
1) The User Interface Class 108 includes a Display 122 non-real-time thread that is responsible to continuously update the display of the data and runs with a period of approximately πd;
2) The Watchdog thread 118 has a period of approximately πs;
3) The hardware Watchdog 116 has a period of πh;
4) The DSP of the MC board 114 runs a real-time thread with a period dependent on the model used, but normally very fast.

The actual values of these periods is set depending on the specific robotic application, with faster checks being required for fast motion and critical tasks. Specifically, πₕ is set based on the largest time interval that is considered safe for the robot to run unsupervised. The other two periods are set so that:

πₛ<πₕ consistently

and πₛ<π_{d} for efficiency

With several concurrent processes running, it is possible that commands could overlap, be incompatible, and possibly crash the software. For example, the Display thread 122 may ask for data at the same time when this is loaded by the Watchdog thread 118 from the MC board 114. As such, a thread-safe code structure is required. This is implemented with a thread-safe Semaphore of the Robot class (sema) 128. During each πₛ cycle, the Watchdog thread 118 keeps sema 128 locked for as long as it talks to the MC board 114 and processes data, and unlocks sema 128 when it sleeps waiting for the period πₛ to complete. The wait, f πₛ, is a fraction of πₛ that is tuned or timed so that the Watchdog period averages πₛ. Interaction of the User Interface 108 methods with the Robot 110 is allowed only when the sema 128 is unlocked. Moreover, all thread sensitive methods wait for the sema 128 to unlock, then take control of the sema 128 locking it, perform their tasks, and finally release sema 128 when done. As such, the sema 128 serializes all thread sensitive activities, therefore avoiding possible parallel and possibly conflicting activities. The primary thread is the Watchdog 118. Other methods run when the Watchdog 118 sleeps, that is when:

sema→release;Sleep(fπₛ);

Wait for sema then sema→lock;

To avoid thread conflicts with the MC 114, it is only the Watchdog thread 118 that communicates with it. As such, commands that the user places at arbitrary times (robot→postCommand) are passed to the Robot 110, which posts them in a que (cmd) that is processed by the Watchdog 118.

The Watchdog thread:
1) Reads all necessary data form the MC 114;
2) Performs necessary calculations such as kinematics and dynamics;
3) Runs multiple system checks including the errors reported by the MC 114, robot sensors, the state of the Emergency Stop 119, if the hardware Watchdog 116 is up (wdOK, from MC), but also that other components of the software are running (for example softOK);
4) Based on the checks, the watchdog may automatically post commands to the cmd que to implement safety. For example it issues a Power Off command in case that the hardware watchdog went down to synchronize states between the hardware and software;
5) Update the state of a Visual Status alert that is included in hardware to signal the major states of the system to the user;
6) Process the cmd que depending on priorities and Send the commands to the MC 119;
7) If all checks are passed (allOK), the watchdog 118 sends a pulse to the hardware watchdog 116 to keep it up. Otherwise, power is allowed to laps.
8) Finally, the watchdog 118 sleeps allowing other activities to proceed as needed.

As such, the hardware watchdog 116 interrupts the drive power should a crash or excessive (>πₕ) delay of the watchdog thread 118 occur, so that the robot 100 may not run unsupervised. Disconnecting drive power will stop motion in case that the robot 100 is non-backdrivable. Otherwise, if the unpowered robot 100 can move under gravity or other loads, the robot manipulator should be equipped with normally closed brakes that are unlocked by the Drive Power, to lock the robot if power is lost.

Other software components may also be critical to safety, for example the User Interface 108. As such, among other checks, the Watchdog thread 118 also verifies that the Display thread 122 is running (softOK). The Robot keeps track of the Display 122 running by the frequency with which it requests data (robot→get(state)). The Display 122 normally runs at a lower frequency (1/π_{d}<1/πₛ) because it is inefficient to display data faster than it is acquired. The Display thread 122 is therefore considered operational if and only if it requests data within several watchdog cycles (n πs):
If (ui requests data within n πs) then softOK;

Other software components may be monitored similarly, by their direct or indirect (propagated similarly) interaction with the Robot class.

Overall, the hardware watchdog 116 makes sure that the computer that runs the software watchdog is connected and the software watchdog runs. In turn, the software watchdog performs comprehensive system checks, including the hardware watchdog, and other software components. Robot drive power is suspended should a serious faulty condition exist.

A watchdog circuit was designed according to the requirements of the hybrid software-hardware watchdog:
R1) Bring up the output if and only if the software computer and the hardware are connected.
R2) Bring up the output if and only if pulses and start signal are present;
R3) Keep up the output if and only if the input pulses are shorter than a hardware preset value, πₛ<πₕ.
1) Software pulses may fail in up or down states. As such, perform a Fail-Down Check and drop the output if the INPUT does not raise within πₕ.
2) Perform a Fail-Up Check and drop the output if the INPUT does not fall within πₕ.
3) Combine 1 & 2 above to drop the output in a Fail-Up AND Fail-Down case.
4) The output of 3 is restored as soon as the train of pulses is restarted. To prevent this, latch it to the START signal to obtain the OUTPUT. As such:
   a. Fail-Down test: OUTPUT raises with pulses and START, falls on Fail-Down, and does not restart WHEN pulses are restored.
   b. Fail-Op test: OUTPUT raises with pulses and START, falls on Fail-Up, and does not restart WHEN pulses are restored.

As such, tests 4a and 4b satisfy both the R2 and R3 requirements of the hardware watchdog.

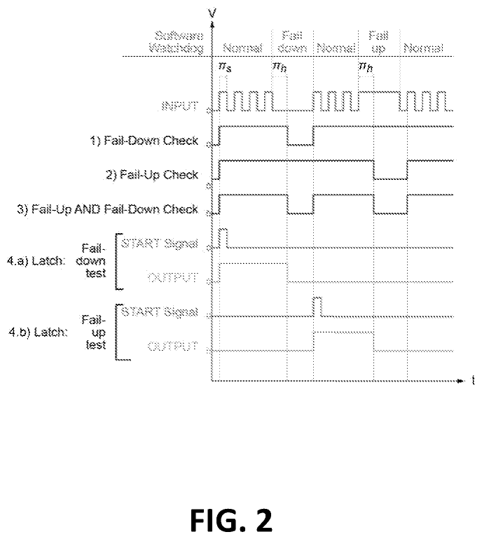

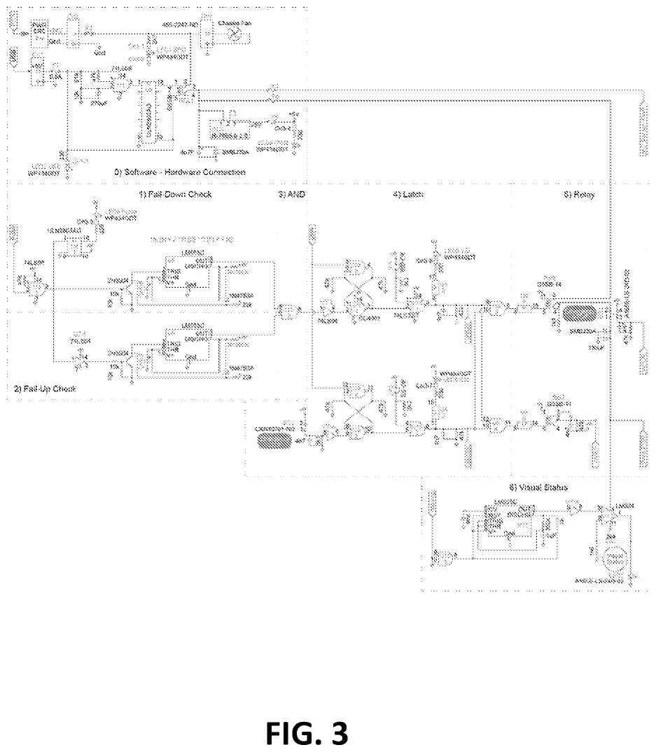

A circuit was designed according to steps 1-4 described, above, and as shown in FIG. 2, combining digital logic circuits in a way that accomplishes the design requirements. FIG. 2 illustrates a schematic view of circuit blocks according to an embodiment of the present invention. Components were also included according to the requirements of the Software-Hardware Watchdog described in Section 2.2 (FIG. 1), and additional safety checks. A possible implementation is presented in FIG. 3. FIG. 3 illustrates a schematic view of a hardware watchdog electronic circuit according to an embodiment of the present invention.

Here, circuit blocks are identified numerically, and blocks 1-4 correspond to those in FIG. 2, as follows:
0) Software-Hardware Connection: The Software Watchdog runs on a computer that is connected to the MC on the Hardware side (Connect, FIG. 1). This is often made over a USB connection. This connection is the first to be checked by the Hardware Watchdog, as shown in FIG. 3. This circuit, is supplied with POWER from an external source. Here, it is shown as a 24V DC supply, but other sources may be used similarly depending on the requirements of the robot.
   The circuit is powered by the 5V DC of the USB connection. A timer made with an AND gate (U1) is used to allow the USB connection to be established prior to that of POWER. In this setup the delay is approximately 3 s. At the same time, the Drive Power will be interrupted, should the USB be disconnected to prevent the MC to remain unsupervised. The POWER is then supplied through a relay (REL1) fed by a Darlington Transistor Arrays (U2).
   This POWER, which will not be interrupted by the Watchdog is made available to power robot sensors and the MC (MC Sensors PWR). In addition this power is used to generate with a DC-DC converted (DC1) the 5V DC power for all the other components of the watchdog circuit. A fan for the chassis of circuit, MC, and typically the motor drivers is powered by direct supply. All power lines are protected with fuses (F1-F5). Finally, three LEDs are included and attached with connectors so that they can be placed at a visible location on the chassis. Their signals are described in Table 1.
1) Fail-Down Check: This is similar to a missing clock or pulse detection circuit. A circuit that is based on a 555 timer (U5) is used, as shown in FIG. 3. This takes as input the train of pulses from the Software Watchdog (FIG. 1), and it output corresponds to the Fail-Down Check of FIG. 2. An LED is used to display the pulses (Table 1).
2) Fail-Up Check: This is similar to the circuit above but operates on the inverted Pulse signal.
3) Fail-Down AND Fail-Up Check: This combines the output of the two checks above.
4) Latch: A first part of the circuit is used to latch the output of checks 2&3 above with a reset signal so that the power can only be started with both Pulses and Start (WatchdogStart( ), FIG. 1). In addition, a second latch is used for a second Emergency Stop (ES2) with a momentary switch to be placed on the robot manipulator. A momentary, single pole switch is preferable
   Both latches are reset by the same Start signal. Their status is reported independently to the Software (wdOK, esOK, FIG. 1) and displayed through LEDs 5&6 (Table 1). Their outputs are combined (U3-3&4) into a redundant system of outputs. Redundancy was used to mitigate the failure or relays in the next block.
5) Relay: The checks above are used to bring up the Drive Power through relay Rel2, is further serialized with the main Emergency Switch (ES1). A redundant branch of the checks is used to power a second relay (Rel3) that posts an Emergency Stop message to the MC. The two systems are redundant, mitigating the likelihood of having the robot powered due to relay failure.
6) Visual Status: Drive Power and an additional sihnal from the MC (FIG. 1), typically showing if the robot is in motion (Moving) are combined to display the status of the system on LED7 ( ).

TABLE 1
Circuit LEDs

| LED | Name | Type | Signals |
|---|---|---|---|
| LED1 | SRC | On/Off Solid | Source POWER connected |
| LED2 | USB | On/Off Solid | USB cable connected |
| LED3 | PWR | On/Off Solid | Watchdog and MC powered |
| LED4 | Pulse | Pulses | Displays the pulses sent |
| | | | by the Software Watchdog |
| LED5 | WD | On/Off Solid | The software watchdog runs and |
| | | | the hardware watchdog is up |
| LED6 | ES2 | On/Off Solid | The Emergency Switch 2 was not |
| | | | depressed since the watchdog was |
| | | | started |
| LED7 | Visual | Off/On/Blinking | Off: Drive Power Off |
| | Status | | On: Drive Power On |
| | | | Blinking: Robot in motion |
| | | | (typically) |

The novelty of the presented approach is the overall structure that puts together a framework to monitor real-time and non-real time processes together with human supervision and specifics of the preferred embodiment.

A preferred embodiment clearly details the software processes and circuits of the hybrid watchdog. It details how to combine safely software threads with real-time processes, the hardware watchdog, emergency switches, together with a MC. While individual electronic circuits and components are ubiquitous, the hardware and software embodiment of the presently described is novel. Combining the fail up-down tests and latches and the overall logic described herein (FIG. 2) is original and enhances safety concerning potential transient glitches.

The use of a system of Emergency Switches including simpler momentary single pole switches is also novel within the given hardware embodiment. These simpler and smaller switches can be placed at various locations including the manipulator to facilitate immediate operator access for increased safety.

Watchdog failure is mitigated with system redundancy that that controls different mechanisms of preventing inadvertent robot motion, on the Drive Power as well as the MC Emergency Stop. Here, redundancy is built within the same system and activates different mechanisms to prevent safety failures.

It should be noted that the software associated with the present invention is programmed onto a non-transitory computer readable medium that can be read and executed by any of the computing devices mentioned in this application. The non-transitory computer readable medium can take any suitable form known to one of skill in the art. The non-transitory computer readable medium is understood to be any article of manufacture readable by a computer. Such non-transitory computer readable media includes, but is not limited to, magnetic media, such as floppy disk, flexible disk, hard disk, reel-to-reel tape, cartridge tape, cassette tapes or cards, optical media such as CD-ROM, DVD, Blu-ray, writable compact discs, magneto-optical media in disc, tape, or card form, and paper media such as punch cards or paper tape. Alternately, the program for executing the method and algorithms of the present invention can reside on a remote server or other networked device. Any databases associated with the present invention can be housed on a central computing device, server(s), in cloud storage, or any other suitable means known to or conceivable by one of skill in the art. All of the information associated with the application is transmitted either wired or wirelessly over a network, via the internet, cellular telephone network, RFID, or any other suitable data transmission means known to or conceivable by one of skill in the art.

Although the present invention has been described in connection with preferred embodiments thereof, it will be appreciated by those skilled in the art that additions, deletions, modifications, and substitutions not specifically described may be made without departing from the spirit and scope of the invention as defined in the appended claims.

1. A system for providing robotic control comprising:
a hardware watchdog configured to provide control over a robot manipulator; and
a software watchdog configured to run on a processing device and programmed to provide thread-safe architecture control over real-time and non-real-time processes of the hardware watchdog and the robot manipulator.

2. The system of claim 1 further comprising a system of emergency switches.

3. The system of claim 2 further comprising momentary single pole switches.

4. The system of claim 2 wherein emergency switches of the system of emergency switches are placed at locations throughout the robot manipulator.

5. The system of claim 4 wherein the emergency switches disposed within the robot manipulator are configured to facilitate immediate operator access for safety.

6. The system of claim 1 further comprising a redundancy system configured to prevent safety failures.

7. The system of claim 1 further comprising a watchdog circuit with fail-up and fail-down checks.

8. The system of claim 1 further comprising electronics configured to facilitate a fail-down check, a fail-up check, a fail-down and a fail-up check, latch, relay, and visual status.

9. A hybrid hardware-software watchdog with thread-safe architecture control over real-time and non-real-time processes.

10. The hybrid hardware-software watchdog of claim 9 further comprising a system of emergency switches including momentary single pole switches.

11. The hybrid hardware-software watchdog of claim 10 wherein the system of emergency switches are placed at locations throughout a robot manipulator.

12. The hybrid hardware-software watchdog of claim 11 including the emergency switches disposed within the robot manipulator being configured to facilitate immediate operator access for safety.

13. The hybrid hardware-software watchdog of claim 9 further comprising a redundancy system that uses different mechanisms to prevent safety failures.

14. The hybrid hardware-software watchdog of claim 9 further comprising a watchdog circuit with fail-up and fail-down checks.

15. The hybrid hardware-software watchdog of claim 9 further comprising electronics configured to facilitate a fail-down check, a fail-up check, a fail-down and a fail-up check, latch, relay, and visual status.

16. A method for robotic control comprising:
using a hardware watchdog configured to provide control over a robot manipulator; and
using a software watchdog configured to run on a processing device and programmed to provide thread-safe architecture control over real-time and non-real-time processes of the hardware watchdog and the robot manipulator.

17. The method of claim 16 further comprising using a redundancy system configured to prevent safety failures.

18. The method of claim 16 further comprising using a watchdog circuit with fail-up and fail-down checks.

19. The method of claim 16 further comprising using electronics configured to facilitate a fail-down check, a fail-up check, a fail-down and a fail-up check, latch, relay, and visual status.

20. The method of claim 16 further comprising using a system of emergency switches.
